(19) United States
(12) Patent Application Publication
(10) Pub. No.: US 2009/0031565 A1
(43) Pub. Date: Feb. 5, 2009

(54) PROCESS FOR MANUFACTURING EXHAUST GAS TREATMENT DEVICE

(76) Inventor: Markus KONTZ, Saarbrucken (DE)

Correspondence Address: MCGLEW & TUTTLE, PC, P.O. BOX 9227, SCARBOROUGH STATION, SCARBOROUGH, NY, 10510-9227, US

(21) Appl. No.: 12/145,683

(22) Filed: Jun. 25, 2008

(30) Foreign Application Priority Data
Jun. 26, 2007 (DE) 10 2007 029 636.5

(51) Int. Cl. B21D 51/10; B23P 19/04; B23P 19/02

(52) U.S. Cl. 29/890; 422/179

(57) ABSTRACT

A process is provided for manufacturing an exhaust gas treatment device (2), which has an exhaust gas treatment insert (4), which is clamped in a housing (8) by at least one mounting mat (6) enveloping the insert (4). An individual geometry of the housing (8), which geometry is individually adapted to the particular insert (4) and to the particular mounting mat (6), is determined as a function of the weight of the particular insert (4) and of the particular mounting mat (6). The housing (8), the particular insert (4) and the particular mounting mat (6) are mounted as a function of the individual geometry determined. The quality of manufacture can be improved if the geometry is determined such that a predetermined clamping force is present in the mounted state and if the weight of the particular mounting mat (6) is determined separately and is taken into account separately in the determination of the geometry.

### CROSS REFERENCE TO RELATED APPLICATIONS

This application claims the benefit of priority under 35 U.S.C. § 119 of German Patent Application DE 10 2007 029 636.5 filed Jun. 26, 2007, the entire contents of which are incorporated herein by reference.

### FIELD OF THE INVENTION

The present invention pertains to a process for manufacturing an exhaust gas treatment device with

### BACKGROUND OF THE INVENTION

DE 10 2005 025 426 A1 discloses a process for manufacturing exhaust gas treatment device, in which the particular exhaust gas treatment device has an exhaust gas treatment insert, which is clamped in a housing by means of a mounting mat enveloping the insert. Depending on the weight of the insert and the mounting mat, a geometry of the housing, which is individually coordinated with the insert and the mounting mat, is determined at the time of the manufacture of the exhaust gas treatment device. The housing, insert and mounting mat are subsequently mounted as a function of the individual geometry determined. Exhaust gas treatment device, e.g., catalytic converters and particle filters, comprise corresponding inserts, e.g., catalytic converter elements and particle filter elements, which are subject to tolerances in connection with their manufacture. The inserts are clamped in the particular housing by means of the mounting mat at the time of manufacture of the exhaust gas treatment device, i.e., the particular insert is fixed in the housing by radial pressing of the mounting mat radially between the insert and the housing. The mounting mat must guarantee reliable fixation of the insert in the housing over the temperature range that is possible during the operation of the exhaust gas treatment device. This operating temperature range may be between −40° C. and +1,000° C. Since the metallic housing expands markedly more greatly due to the temperature than, for example, a ceramic insert, the mounting mat must be pressed or prestressed comparatively strongly during mounting, which is usually carried out at ambient temperature, in order to make it possible to guarantee sufficient fixation for the insert in the housing at the high temperatures possible during the operation as well. The clamping force must not be selected to be too strong fore the manufacture, because, on the one hand, ceramic inserts are comparatively susceptible to breakage and, on the other hand, a certain reserve must be taken into account for the lower operating temperature range.

Because of their manufacture, ceramic inserts have tolerances. Tolerances concerning the diameter or concerning the cross section are critical here. To make it possible to set the clamping force optimally in case of inserts that have individual cross sections or diameters, the geometry of the housing is adapted individually in the prior-art manufacturing process. The weight of the insert is determined for this together with the mounting mat to determine the optimal housing geometry in order to make it possible to calculate the diameter or the cross section at a given density and at a given length dimension. It is assumed in the prior-art process that the weight of the mounting mat is usually markedly lower than the weight of the insert and it is therefore also subject to markedly narrower tolerances. The joint determination of the complete weight of the insert around which the mounting mat is wound is said to lead to acceptable errors.

### SUMMARY OF THE INVENTION

The present invention pertains to the object of proposing an improved embodiment for a manufacturing process of the type mentioned in the introduction, which embodiment is characterized especially in that the adaptation of the housing to the particular insert with the particular mounting mat is improved, which can be used to improve the quality of manufacture.

The present invention is based on the general idea of determining the weight of the mounting mat per se in order to make it possible to take it into account separately in the determination of the housing geometry. Furthermore, the housing geometry is determined in the manufacturing process according to the present invention such that a predetermined clamping force is reached in the mounted state. The present invention utilizes here the discovery that the manufacturing tolerances of the mounting mat are not negligible by any means, but certainly have significant effects on the clamping force that can be attained. For example, it was found that the mounting mats can be manufactured comparatively accurately concerning their base as well as concerning their density, while relatively great deviations may arise in the strength of the mat, i.e., in the thickness or height of the mat. If the base and the weight are known, the thickness of the mounting mat can be determined comparatively accurately based on the weight of the mounting mat, and this thickness can be taken into account correspondingly in the determination of the optimal housing geometry. Since, unlike the insert, the mounting mat is compressible, the weight of the mounting mat or the thickness of the mounting mat is advantageously taken into account in the determination of the housing geometry in a different way than the way in which the weight of the insert or the cross section of the insert is taken into account. The different physical boundary conditions of the compressibility as well as of the spring elasticity of the mounting mat are taken into account as a result better than in a manufacturing process that only adds the weight of the mounting mat to the weight of the insert in order to thereby determine quasi a common cross section in order to determine the housing geometry with this common value.

In addition, the separate determination of the weight of the mounting mat for both the particular insert and for the particular mounting mat makes possible the permanent monitoring of the tolerance ranges for the inserts and the mounting mats, each time in itself. The quality of manufacture can be considerably improved hereby as well within the framework of the production of a large series.

According to an advantageous embodiment, the weight of the particular mounting mat can be determined in a mat feeding means, which is used to feed the particular mounting mat to an automatic winding means, the latter being used to wind the particular mounting mat around the particular insert. As an alternative, the weight of the particular mounting mat may also be determined in such an automatic winding means. At any rate, the weighing of the particular mounting mat can be integrated within the manufacturing process such that no additional weighing station is necessary or no additional manufacturing time is needed.

According to another embodiment, the weight of the particular mounting mat can be determined by a difference measurement, during which the weight of the particular insert without the particular mounting mat is determined, on the one hand, and the weight of the particular insert with the particular mounting mat is determined, on the other hand. The individual weights as well as the total weight of the particular combination of insert and mounting mat can be determined in a simple way by weighing the particular insert once with and once without the particular mounting mat.

Other important features and advantages of the present invention appear from the claims, from the drawings and from the corresponding description of the figures on the basis of the drawings. It is apparent that the above-mentioned features, which will be explained below, are applicable not only in the particular combination indicated, but in other combinations or alone as well without going beyond the scope of the present invention. Preferred exemplary embodiments of the present invention are shown in the drawings and will be explained in more detail in the following description. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 shows a greatly simplified, circuit diagram-like schematic view of a unit for manufacturing exhaust gas treatment device.

### DESCRIPTION OF THE PREFERRED EMBODIMENTS

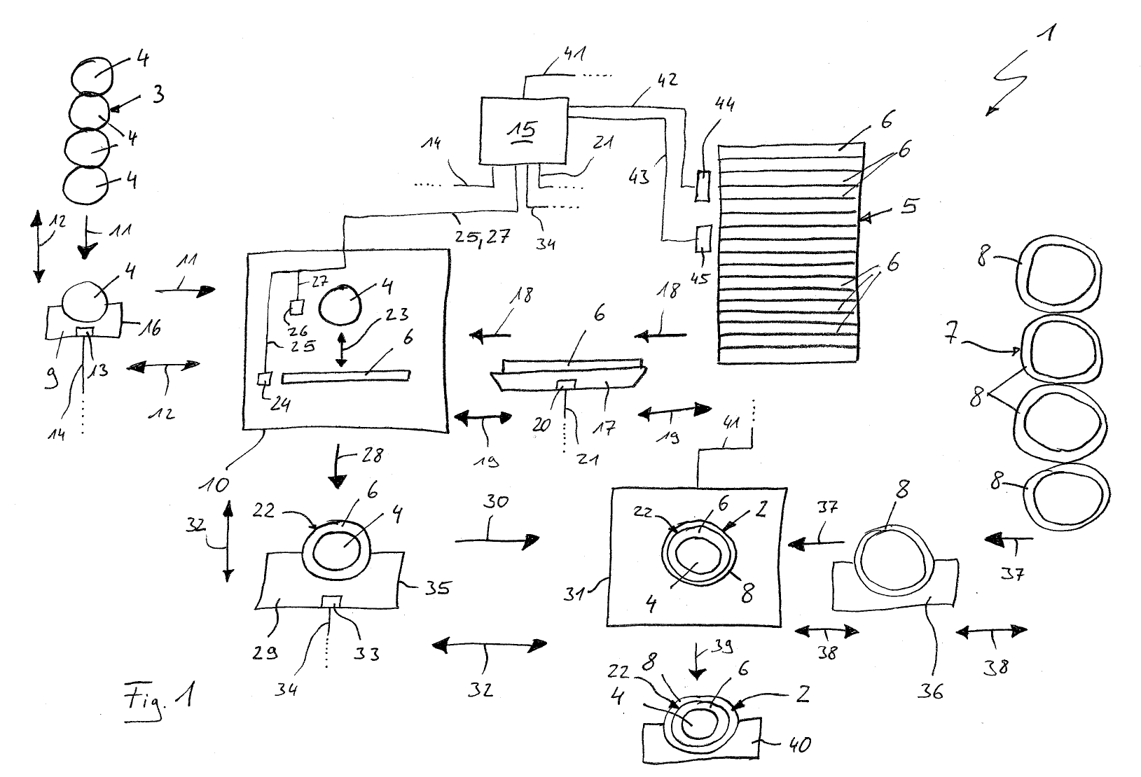

Referring to the drawings in particular, Corresponding to FIG. 1, a unit 1, by means of which exhaust gas treatment device 2 can be manufactured, may have a plurality of stations. In a purely exemplary manner and without restriction of the general scope, unit 1 comprises here an insert hopper 3, which is used to store individual exhaust gas treatment inserts 4, which will hereinafter also be called insert 4 for short. The inserts 4 may be, for example, particle filter elements or catalytic converter elements. These may be manufactured, in principle, from metal. However, the inserts 4 preferably consist of a ceramic material. In particular, they may be designed as ceramic monoliths. The exhaust gas treatment device 2, which can be manufactured by means of unit 1, are correspondingly advantageously catalytic converters or particle filters.

Unit 1 has, besides, a mounting mat hopper 5, in which individual mounting mats 6 are stored. These mounting mats 6 are used to be wound around as well as to mount and fix the inserts 4, one particular mounting mat 6 being preferably used to be wound around one particular insert 4. The mounting mats 6 are dimensioned in respect to their base such that they are wound around the particular insert 4 exactly once. In the ideal case, the hems of the mounting mat 6 abut against each other without mutual overlap in the circumferential direction when the particular mounting mat 6 surrounds or envelops the corresponding insert 4.

Furthermore, unit 1 has a housing hopper 7, which is used to store housings 8 of the exhaust gas treatment device 2. The housings 8 are usually tubular metal bodies, in which the particular insert 4 is arranged and fixed by means of the particular mounting mat 6. The insert 4, mounting mat 6 and housing 8 are arranged coaxially in one another in the mounted state, the mounting mat 6 being arranged radially between the insert 4 and the housing 8 and pressed radially. Since the mounting mat 6 has a certain elasticity, a clamping force is generated as a result for clamping the insert 4 in the housing 8. This clamping force is selected to be such that the insert 4 guarantees sufficient fixation and mounting of the insert 4 in the housing 8 over the entire range of the possible temperatures that may occur during the operation of the exhaust gas treatment device 2, which may range, for example, from −40° C. to +1,000° C. Furthermore, the clamping force shall take into account certain reserves for aging and settling phenomena in the material of the mounting mat 6.

Unit 1 comprises an insert feeding means 9, which is designed to feed the particular insert 4 to an automatic winding means 10. The insert feeding means 9 can pick up the particular insert 4 from the insert hopper 3 and transfer it to the winding means 10. The motions of the inserts 4 are indicated here by the arrows 11, while the adjusting motions of the insert feeding means 9 are indicated by double arrows 12. The insert feeding means 9 may be, for example, a carriage or a gripping arm or the like. According to a special embodiment, a sensor system 13, which makes it possible to determine the weight of the particular insert 4 being transported in the insert feeding means 9, may be integrated within the insert feeding means 9. This sensor system 13 can communicate with a control 15 via a corresponding signal line 14. If the insert feeding means 9 is equipped with such a sensor system 13, it can be used as a weighing means 16.

Unit 1 has, furthermore, a mat feeding means 17, which may have, for example, a carriage or a gripper or the like. The mat feeding means 17 is used to feed the particular mounting mat 6 to the winding means 10. The mat feeding means 17 picks up for this the particular mounting mat 6 at the mat hopper 5 and transfers same to the winding means 10. The direction of motion of the mounting mats 6 is symbolized here by arrows 18, while the reversible adjusting motions of the mat feeding means 17 are indicated by double arrows 19. According to an advantageous embodiment, a sensor system 20, which communicates with the control 15 via a corresponding signal line 21, may be integrated in the mat feeding means 17. This sensor system 20 may be designed such that the weight of the mounting mat 6 in the mat feeding means 17 can be determined with it.

The winding means 10 is designed to automatically wind the particular mounting mat 6 fed in around the particular insert 4 fed in order to thus form a unit comprising an insert 4 and a mounting mat 6. This unit will hereinafter be called a core 22. The converging of the insert 4 and the mounting mat 6 in the winding means 10 is indicated by a double arrow 23. The winding means 10 operates automatically, so that, in particular, no assembly worker has to touch the insert or the mounting mat 6, as a result of which contaminations can be avoided. Corresponding to a preferred embodiment, the winding means 10 may have a sensor system 24, by means of which the weight of the mounting mat 6 can be determined within the winding means 10. This sensor system 24 likewise communicates with the control 15 via a corresponding signal line 25. In addition or as an alternative, the winding means 10 may have a sensor system 26, which likewise communicates with the control 15 via a corresponding signal line 27 and by means of which the weight of the insert 4 can be determined within the winding means 10. The winding means 10 may likewise have a sensor system, which is not shown here, and by means of which the total weight of the insert 4 wound around with the mounting mat 6 can be determined.

After the insert 4 has been wound around with the mounting mat 6, the core 22 thus formed is transferred corresponding to an arrow 28 into a core feeding means 29. The core 22 can be fed to a mounting means 31 corresponding to arrow 30 with the core feeding means 29. A corresponding adjustability of the core feeding means 29 is indicated by double arrows 32. The core feeding means 29 may have, for example, a carriage or a gripping arm or the like. According to an advantageous embodiment, the core feeding means 29 may have a sensor system 33, by means of which the weight of the core 22, i.e., the weight of the insert 4 and the mounting mat 6 together, can be determined. The sensor system 33 likewise communicates with the control 15 via a corresponding signal line 34. If the core feeding means 29 is equipped with such a sensor system 33, it can be used as a weighing means 35.

Unit 1 is equipped, in addition, with a housing feeding means 36, which is designed such that it feeds the particular housing 8 to the mounting means 31. The housing feeding means 36 picks up for this the particular housing 8 in the housing hopper 7 and transfers this corresponding to arrows 37 to the mounting means 31. Corresponding adjusting motions of the housing feeding means 36 are indicated by double arrows 38 here. The housing feeding means 36 may have a gripping arm or a carriage or the like.

The mounting means 31 is used to mount the housing 8 and the core 22. On the one hand, the core 22 is introduced for this into the housing 8. On the other hand, the housing 8 is provided with a geometry coordinated individually with the core 22. Various possibilities are conceivable for this. For example, the housing 8 may be stored in the housing hopper 7 in the form of a housing blank, which is oversized in respect to the core 22 to be received. Calibration of the housing 8 to the desired geometry is then carried out in the mounting means 31. It is equally possible to store in the housing hopper 7 housings 8 with predetermined, different geometries, which will then be selected individually for the particular core 22 in order to subsequently introduce this into the housing 8 in a suitable manner. It is also possible, in principle, to provide the housing 8 not as a blank, but as a monocoque construction, in which case the shells, preferably half shells, will then be attached to one another with the core 22 inserted in the mounting means 31.

After mounting, the exhaust gas treatment device 2 leaves the mounting means 31 corresponding to an arrow 39 and can be removed, for example, by means of a corresponding conveying means 40.

Unit 1 can be operated, for example, as follows:

To make it possible to fix the particular insert 4 in the housing 8 by means of the particular mounting mat 6 with a predetermined clamping force, the control 15 determines, individually for each core 22, i.e., individually for the particular combination of insert 4 and mounting mat 6, a geometry for the housing 8, which geometry is specially adapted for this. The geometry is determined as a function of the weight of the insert 4 and the weight of the mounting mat 6. The control 15 cooperates for this with the mounting means 31 via a suitable control line 41 in a suitable manner.

It is of particular significance here that the control 15 determines the weights of the insert 4 and of the mounting mat 6 separately and also takes these weights into account separately in the determination of the housing geometry, i.e., in a suitable manner. For example, the control 15 can determine the height or the thickness of the mounting mat 6 from the weight of the mounting mat 6. Control 15 assumes here that a base as well as a density of the mounting mat 6 are relatively constant, so that essentially only a variation in the thickness of the mat can lead to different mat weights. Correspondingly, when determining the optimal housing geometry, control 15 preferably takes into account the thickness of the mounting mat, which it determines from the weight of the mat. The weight of the mounting mat 6 can be determined, for example, in the mat feeding means 17 by means of the sensor system 20 present there. The determination of the mat weight can thus be integrated in the process without the manufacturing time being affected. However, a separate weighing means, which is arranged upstream of the winding means 10, is also conceivable, in principle.

As an alternative, the weight of the mounting mat may also be determined by the sensor system 24 in the winding means 10.

Furthermore, it is possible, in principle, to determine the weight of the mounting mat 6 by a difference measurement. In such a difference measurement, the weight of the insert 4 is determined before the application of the mounting mat 6, on the one hand. On the other hand, the weight of the insert 4 is determined after the mounting mat 6 has been wound around the insert 4. The weight of the insert 4 can be calculated by forming the difference, so that the weight of the mounting mat 6 remains. For example, measurement of the weight of the insert 4 without mounting mat 6 by means of sensor system 26 in the winding means 10 is conceivable. Furthermore, the weight of the insert 4 can be determined in a separate weighing means 16, which is arranged upstream of the winding means 10. In particular, this weighing means 16 may be formed by the insert feeding means 9 if this is equipped with the sensor system 13. A suitable sensor system (not shown here) may again be present, in principle within the winding means 10 for measuring the weight of the core 22, i.e., for determining the weight of the insert 4 wound around with the mounting mat 6. A separate weighing means 35, which is arranged downstream of the winding means 10, may be used for this as well. Such a weighing means 35 may be embodied, in particular, by the core feeding means 29, if this is equipped with the sensor system 33.

According to an especially advantageous variant, the control 15 may optionally also be designed such that it takes into account, for example, a moisture content and/or a temperature of the mounting mat 6 or of the corresponding insert 5 in the determination of the housing geometry coordinated individually with the combination of the insert 4 and the mounting mat 6 belonging to it. Purely as an example, the control 15 may be coupled with a moisture sensor 44 or with a temperature sensor 45 via corresponding signal lines 42 and 43, respectively. The sensors 44, 45 may be arranged, for example, in the mat hopper 5. By taking such additional parameters into account, further optimization can be achieved in the manufacture of an individually adapted geometry of housing 8.

While specific embodiments of the invention have been shown and described in detail to illustrate the application of the principles of the invention, it will be understood that the invention may be embodied otherwise without departing from such principles.

What is claimed is:

1. A process for manufacturing an exhaust gas treatment device, which has an exhaust gas treatment insert, which is clamped in a housing by means of at least one said mounting mat enveloping the insert, the process comprising:
determining an individual geometry of the housing, which geometry is adapted to the particular insert and to the particular mounting mat, as a function of the weight of the particular insert and of the particular mounting mat wherein the geometry is determined such that a predetermined clamping force is present in the mounted state and the weight of the particular mounting mat is determined separately and is taken into account separately in the determination of the geometry;
mounting the particular insert and the particular mounting mat to the housing as a function of the individual geometry determined.

2. A process in accordance with claim 1, wherein the height or thickness of the particular mounting mat is determined from the weight of the particular mounting mat in case of known mounting mat base and known mounting mat density.

3. A process in accordance with claim 1, wherein a thickness of the particular mounting mat is taken into account in the determination of the geometry.

4. A process in accordance with claim 1, wherein the weight of the particular mounting mat is determined in a mat feeding means for feeding the particular mounting mat to an automatic winding means for winding the particular mounting mat around the particular insert.

5. A process in accordance with claim 1, wherein the weight of the particular mounting mat is determined in an automatic winding means for winding the particular mounting mat around the particular insert.

6. A process in accordance with claim 1, wherein the weight of the particular mounting mat is determined by a difference measurement, in which the weight of the particular insert without said mounting mat, is determined, on the one hand, and the weight of the particular insert with the particular mounting mat, is determined, on the other hand.

7. A process in accordance with claim 6, wherein the weight of the particular insert with the particular mounting mat is determined in an automatic winding means for winding the particular mounting mat around the particular insert or in a separate weighing means, which separate weighing means is arranged downstream of such a winding means.

8. A process in accordance with claim 6, wherein the weight of the particular insert is determined in an insert feeding means for feeding the particular insert to an automatic winding means for winding the particular mounting mat around the particular insert.

9. A process in accordance with claim 1, wherein the weight of the particular insert is determined in an automatic winding means for winding the particular mounting mat around the particular insert or in a separate weighing means, which is arranged upstream of such a winding means.

10. A process in accordance with claim 1, wherein a moisture content and/or a temperature of the particular mounting mat and/or of the particular insert is/are taken into account in the determination of the geometry.

11. A process for manufacturing an exhaust gas treatment device, the process comprising the steps of:
providing an exhaust gas insert;
providing a particular mounting mat of a known base dimension;
providing a housing;
adapting a geometry of housing to the particular insert and to the particular mounting mat, as a function of the weight of the particular insert and of the particular mounting mat;
clamping the exhaust gas treatment insert in the housing by means of the mounting mat enveloping the insert wherein the geometry is determined such that a predetermined clamping force is present in the mounted state and the weight of the particular mounting mat is determined separately and is taken into account separately in the determination of the geometry for mounting the particular insert and the particular mounting mat to the housing as a function of the individual geometry determined.

12. A process in accordance with claim 11, wherein the height or thickness of the particular mounting mat is determined from the weight of the particular mounting mat and the dimensions of the base and a known mounting mat density.

13. A process in accordance with claim 11, wherein a thickness of the particular mounting mat is taken into account in the determination of the geometry.

14. A process in accordance with claim 11, wherein the weight of the particular mounting mat is determined in a mat feeding means for feeding the particular mounting mat to an automatic winding means for winding the particular mounting mat around the particular insert.

15. A process in accordance with claim 1, wherein the weight of the particular mounting mat is determined in an automatic winding means for winding the particular mounting mat around the particular insert.

16. A process in accordance with claim 1, wherein the weight of the particular mounting mat is determined by a difference measurement including determining the weight of the particular insert without said mounting mat and determining the weight of the particular insert with the particular mounting mat.

17. A process in accordance with claim 16, wherein the weight of the particular insert with the particular mounting mat is determined in an automatic winding means for winding the particular mounting mat around the particular insert or in a separate weighing means, which separate weighing means is arranged downstream of such a winding means.

18. A process in accordance with claim 16, wherein the weight of the particular insert is determined in an insert feeding means for feeding the particular insert to an automatic winding means for winding the particular mounting mat around the particular insert.

19. A process in accordance with claim 11, wherein the weight of the particular insert is determined in an automatic winding means for winding the particular mounting mat around the particular insert or in a separate weighing means, which is arranged upstream of such a winding means.

20. A process in accordance with claim 11, wherein a moisture content and/or a temperature of the particular mounting mat and/or of the particular insert is/are taken into account in the determination of the geometry.
